(19) United States
(12) Patent Application Publication
(10) Pub. No.: US 2003/0197677 A1
(43) Pub. Date: Oct. 23, 2003

(54) Keyboard/mouse/GPIO interface of a wireless interface device

(76) Inventor: Robert W. Hulvey, Hermosa Beach, CA (US)

Correspondence Address: GARLICK HARRISON & MARKISON LLP, P.O. BOX 160727, AUSTIN, TX, 78716-0727, US

(21) Appl. No.: 10/417,941

(22) Filed: Apr. 17, 2003

Related U.S. Application Data
(60) Provisional application No. 60/373,314, filed on Apr. 17, 2002.
(60) Provisional application No. 60/399,234, filed on Jul. 29, 2002.

(51) Int. Cl. G09G 5/08

(52) U.S. Cl. 345/156

(57) ABSTRACT

A wireless interface device services communications between a wirelessly enabled host and at least one user input device. The wireless interface device includes a wireless interface unit, a processing unit, an input/output unit, and may include a power management unit. The wireless interface unit wirelessly interfaces with the wirelessly enabled host using a communication interface protocol. The input/output unit includes a keyboard interface module, a pointing device interface module, a General Purpose Input/Output (GPIO) module, and a multiplexer. The multiplexer is configurable to couple at least two of the keyboard interface module, the pointing device interface module, and the GPIO module to the at least one user input device. In one configuration, the at least one user input device includes both a keyboard and a pointing device and the multiplexer couples the keyboard to the keyboard interface module and to the GPIO module and couples the pointing device to the pointing device interface module and to the GPIO module.

### CROSS REFERENCE TO RELATED APPLICATION

This application claims priority to U.S. Regular Utility application Ser. No. 10/291,030 filed Nov. 8, 2002, to U.S. Provisional Application Serial No. 60/337,314, filed Apr. 17, 2002, and to U.S. Provisional Application Serial No. 60/399,234, filed Jul. 29, 2002, the disclosure of all of these incorporated herein by reference in their entirety for all purposes.

### BACKGROUND

1. Technical Field

The present invention relates generally to digital computers; and more particularly to wireless interface devices coupled to digital computers.

2. Related Art

Digital computers have been known in the art for years. Personal digital computers typically include a case, a video display, and one or more input/output devices. The case typically includes a power supply, a cooling fan, a motherboard, interface ports, peripheral cards, a disk drive, and other components. Contained on the motherboard are a processor, memory, a processor chip set, and one or more peripheral buses. The peripheral cards interface input/output devices with the motherboard via the peripheral buses. Other input/output devices may couple directly to the motherboard via appropriate connectors, e.g., devices coupled via a parallel port, devices coupled via a serial port, and devices coupled via a USB.

Input devices receive input from a user or another source while output devices provide output to a user or another destination. Keyboards, computer mice, microphones, scanners, etc. are typically considered input devices because they receive input but provide no output. Monitors, speakers, printers, etc. are considered output devices because they provide output to the user but receive no input from the user. Other devices, such as touch sensitive monitors, that both receive input and produce output are considered to be both input and output devices.

Wireless communication technology has rapidly advanced over the past few years. Resultantly, computer input/output devices are now being called upon to wirelessly communicate with their “host” computers. Wireless keyboards and mice now couple via wireless connections to their host computers. These “wireless” input devices provide great benefits in that they require no wired connections with their host computers. However, the lack of a wired connection also requires that the wireless input devices contain their own power supply, i.e., that they be battery powered. In order to extend the life of their batteries the wireless input devices often support power saving modes of operation. Unfortunately, none of these power savings modes reduces power consumption to levels that would extend battery life more than a few weeks. Resultantly, the benefits achieved via wireless connectivity is met or exceeded by the repeated chore and expense of frequently changing batteries in the device.

Thus, there is a need in the art for a wireless input device that operates for an extended period on a single battery life.

### SUMMARY OF THE INVENTION

Thus in order to overcome the shortcomings of the prior devices among other shortcomings within the wireless user interface realm, a wireless interface device constructed according to the present invention services communications between a wirelessly enabled host and a user input device. In some embodiments, the wireless interface device is a single integrated circuit. However, in other embodiments, the wireless interface device may include more than one integrated circuit.

The wireless interface device includes a b system bus, a wireless interface unit, a processing unit, and an input/output unit. The wireless interface unit operably couples to the system bus and wirelessly interfaces the wireless interface device with the wirelessly enabled host. The processing unit operably couples to the system bus and provides a plurality of processing functions of the wireless interface device. The input/output unit includes a keyboard interface module, a mouse interface module, a General Purpose Input/Output (GPIO) module, and a multiplexer. The keyboard interface module operably couples to the system bus and services keyboard inputs and outputs. The mouse interface module operably couples to the system bus and services mouse inputs and outputs, or inputs and outputs from other types of pointing devices. Examples of such pointing devices are trackballs, gyroscopic input devices, joysticks, and game controllers. The GPIO module operably couples to the system bus and services additional inputs and outputs of the user input device. The multiplexer operably couples the keyboard interface module, the mouse interface module, and the GPIO module to the inputs and outputs of the coupled user input device. The multiplexer is configurable to couple input and output signals between the user input device and at least one of the keyboard interface module, the mouse interface module, and the GPIO module.

In one particular application of the wireless interface device, the user input device is a keyboard. In such application, the multiplexer is configurable to couple input signals from the keyboard to the keyboard interface module and to couple output signals from the GPIO module to the keyboard. In another particular application of the wireless interface device, the user input device is a mouse. In this particular application, the multiplexer is configurable to couple input signals from the mouse to the mouse interface module and to couple output signals from the GPIO module to the mouse. Thus, the multiplexer is configurable in a first configuration to couple input signals from the user input device to the keyboard interface module and to couple output signals from the GPIO module to the mouse. Further, the multiplexer is configurable in a second configuration to couple input signals from the user input device to the mouse interface module and to couple output signals from the GPIO module to the mouse.

In still another application of the wireless interface device, the user input device includes both a keyboard and a mouse. In such application, the multiplexer couples input signals from the keyboard to the keyboard interface module and to couple output signals from the GPIO module to the keyboard. Further, the multiplexer couples input signals from the mouse to the mouse interface module. In this application, the multiplexer may also couple output signals from the keyboard interface module to the keyboard, couple output signals from the mouse interface module to the mouse, and couple output signals from the GPIO module to the mouse. In this application, the mouse and the keyboard may be tethered to one another. In such case, the wireless interface device communicatively couples to each of the mouse and the keyboard in a wired fashion.

The wireless interface module may operate according to a particular wireless interface standard such as the Bluetooth Specification. However, in other embodiments, the wireless interface module may operate in a proprietary fashion to support the wireless communication needs of the wireless interface device.

The processing unit of the wireless interface device may also include a mouse interface. In such case, in a first configuration, the wireless interface device services a mouse via the mouse interface of the processing unit. Further, in a second configuration, the wireless interface device services a mouse via the mouse interface module of the input/output unit.

The wireless interface device of the present invention conserves battery power by entering into a plurality of power consumption operating states. These power consumption operating states include a busy mode, an idle mode, a suspend mode, and a power down mode. In the busy mode, all components of the wireless interface device are powered and operational. In the idle mode, all components of the wireless interface device are powered. However, in the idle mode, the wireless interface unit performs first power conserving operations by periodically communicating with the wirelessly enabled host. In the suspend mode, while all of the components of the wireless interface device are powered, the wireless interface unit performs second power conserving operations. Finally, in the power down mode, the wireless interface unit and the processing unit are powered down and communication with the wirelessly enabled host is disabled.

Moreover, other aspects of the present invention will become apparent with further reference to the drawings and specification, which follow.

### BRIEF DESCRIPTION OF THE DRAWINGS

FIG. 1A is a system diagram illustrating a PC host and a wireless mouse that includes a wireless interface device constructed according to the present invention;

FIG. 1B is a system diagram illustrating a PC host and a wireless keyboard that includes a wireless interface device constructed according to the present invention;

FIG. 2 is a schematic block diagram illustrating the structure of a wireless mouse that includes a wireless interface device constructed according to the present invention;

FIG. 3 is a schematic block diagram illustrating the structure of a wireless keyboard that includes a wireless interface device constructed according to the present invention;

FIG. 4 is a block diagram illustrating a wireless interface device (integrated circuit) constructed according to the present invention;

FIG. 5 is a block diagram illustrating a wireless interface unit of the wireless interface device of FIG. 4;

FIG. 6 is a block diagram illustrating a processing unit of the wireless interface device of FIG. 4;

FIG. 7 is a block diagram illustrating an input/output unit of the wireless interface device of FIG. 4;

FIG. 8 is a block diagram generally showing the structure of an integrated circuit constructed according to the present invention with particular detail in the coupling of battery power to the units of the device;

FIG. 9 is a state flow diagram illustrating operation according to the present invention;

FIG. 10 is a state flow diagram illustrating operation according to the present invention in controlling the power consumption of a serviced device;

FIG. 11 is a block diagram illustrating the input/output unit of FIG. 7 configured in a first configuration in which a mouse is serviced;

FIG. 12 is a block diagram illustrating the input/output unit of FIG. 7 configured in a second configuration in which a keyboard is serviced; and

FIG. 13 is a block diagram illustrating the input/output unit of FIG. 7 configured in a third configuration in which both a mouse and a keyboard are serviced.

### DETAILED DESCRIPTION OF THE DRAWINGS

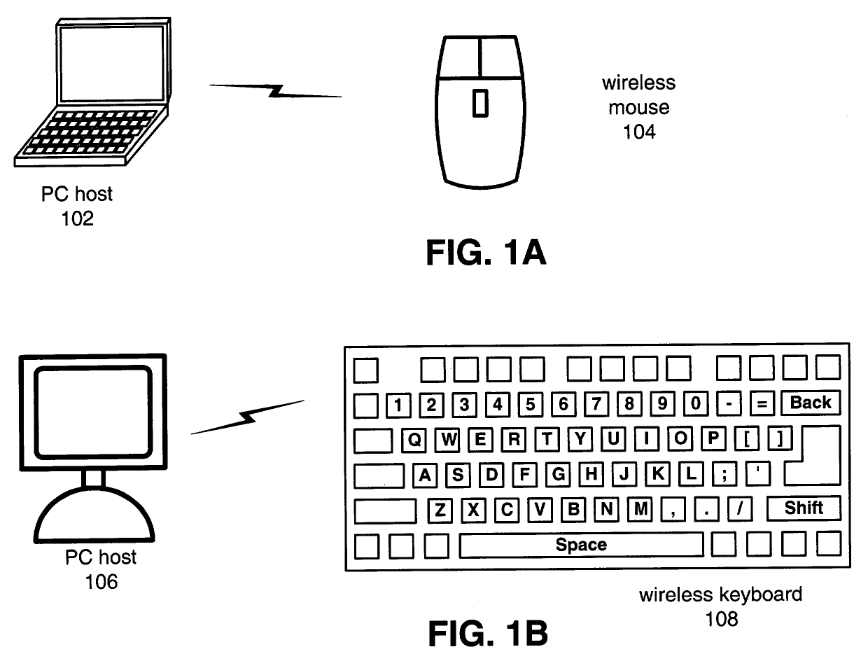

FIG. 1A is a system diagram illustrating a PC host 102 and a wireless mouse 104 (the wireless mouse is an example of a class of devices referred to herein generally as “pointing devices”) that includes a wireless interface device constructed according to the present invention. As shown in FIG. 1A, the PC host 102 wirelessly couples to the wireless mouse 104. In the structure of FIG. 1A, the wireless mouse 104 includes a wireless interface device that operates to place the wireless mouse in any of a number of reduced power operating modes, including a power down mode in which battery life is substantially extended.

FIG. 1B is a system diagram illustrating a PC host 106 and a wireless keyboard 108 that includes a wireless interface device constructed according to the present invention. The wireless keyboard 108 is battery powered and operates for extended periods on a single set of batteries because of the greatly reduced power consumption operations according to the present invention.

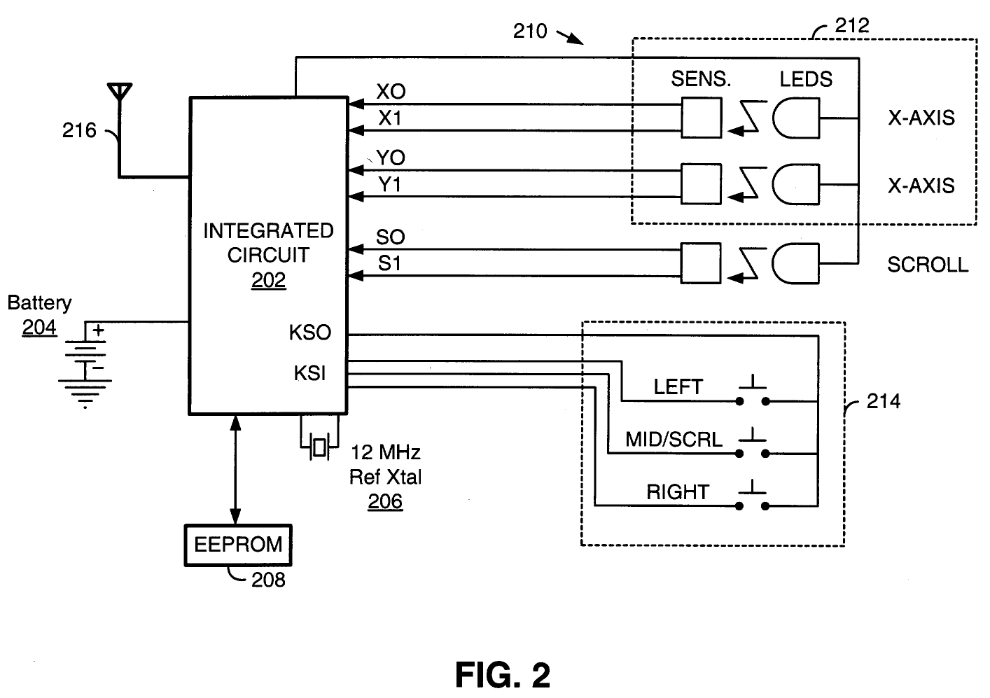

FIG. 2 is a schematic block diagram illustrating the structure of a wireless mouse that includes a wireless interface device constructed according to the present invention. An integrated circuit 202 constructed according to the present invention serves as the wireless interface device and couples to various mouse inputs 210. These mouse inputs 210 include x-axis and y-axis inputs as well as a scroll input, also known as a z-axis input. The x-axis, y-axis, and z-axis inputs are often implemented as what are referred to as “quadrature” inputs. The components that produce the quadrature inputs are generally referred to at numeral 212 and may be constructed from optical inputs instead of from conventional mechanical inputs. Referenced via numeral 214 are the button inputs that are typical with a computer mouse and include the left button input, the middle/scroll button input, and the right button input. Many mice also include additional buttons with extended functions or programmable functions. As is shown, each of the signals produced by the mouse are received by integrated circuit 202.

Integrated circuit 202 also couples to battery 204, crystal 206 that produces a 12 MHz reference frequency, EEPROM 208, and antenna 216. In one embodiment of the present invention, battery 204 comprises a pair of either AA batteries or AAA batteries. Antenna 216 is an internal antenna in the described because of the size constraints of the mouse and because of the relatively short distance between the PC host and the wireless mouse. In some embodiments, the EEPROM 208 may be replaced by non-volatile storage memory embedded in the integrated circuit 202.

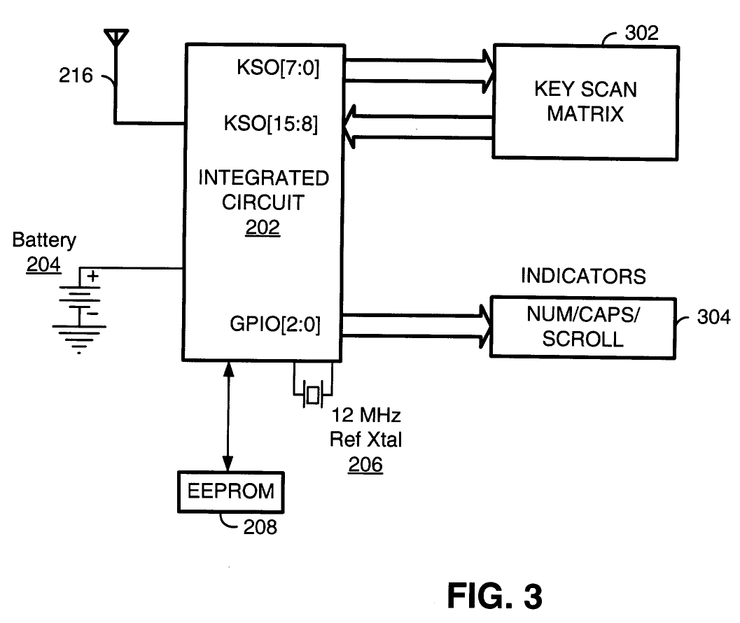

FIG. 3 is a schematic block diagram illustrating the structure of a wireless keyboard that includes a wireless interface device (integrated circuit 202) constructed according to the present invention. As shown in FIG. 3, integrated circuit 202 services a key scan matrix 202 that provides inputs from the keyboard. Indicators 304 include number-lock, capitals-lock, and scroll-lock indicator lights that are lit on the keyboard. Most wired keyboards employ LEDs (light emitting diodes) to serve as indicators. However, many wireless keyboards may not include such LEDs due to the power required to light them, or may use alternative indicator means such as an LCD (liquid crystal display) which requires much lower power. The integrated circuit 202 couples to a battery 204, a crystal 206, an EEPROM 208, and an antenna 216.

In another embodiment (not shown in either FIG. 2 or FIG. 3), the integrated circuit 202 services both mouse and keyboard input and may reside internal to either the mouse or the keyboard. As is relatively apparent to the reader, because the input signals differ, multiplexing or signal sharing may be required. However, different signal lines may be dedicated for keyboard and for mouse inputs such that no signal sharing is required. As is apparent, when the integrated circuit 202 alone services both mouse and keyboard input wired connectivity between the keyboard and the mouse is required. The keyboard and mouse input means may in fact reside within the same physical housing.

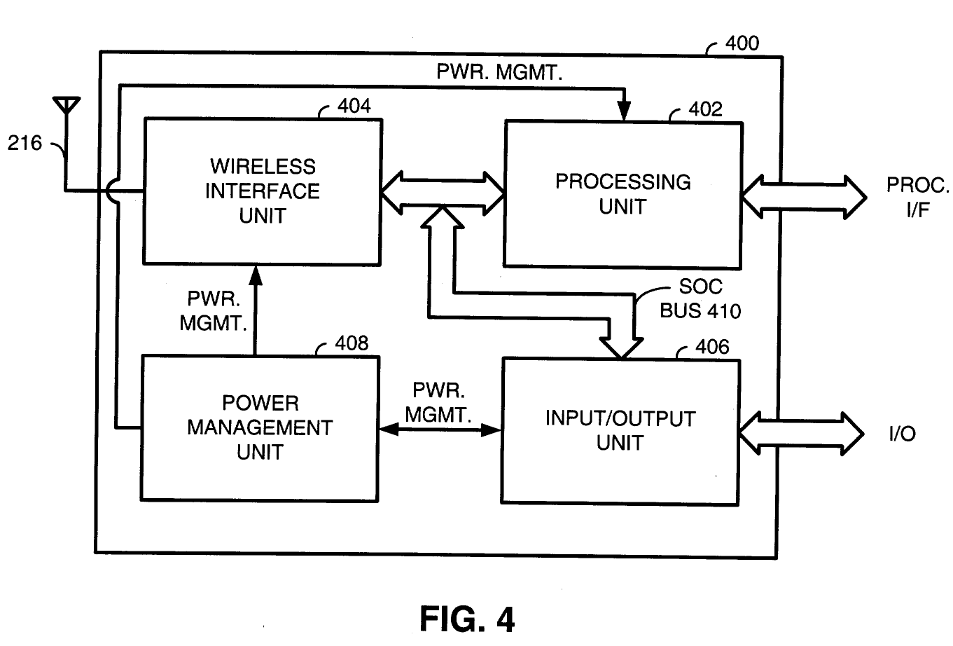

FIG. 4 is a block diagram illustrating a wireless interface device (integrated circuit) constructed according to the present invention. As shown in FIG. 4, the wireless interface device 400 includes a processing unit 402, a wireless interface unit 404, an input/output unit 406, and a power management unit 408. The wireless interface unit 404 couples the wireless interface device 400 to antenna 216. The wireless interface unit 404 operates according to the Bluetooth specification and in particular to the Human Interface Device (HID) portion of the Bluetooth specification.

Processing unit 402, wireless interface unit 404, and input/output unit 406 couple with one another via a system on a chip (SOC) bus 410. Processing unit 402 includes a processing interface that may be used to couple the processing unit to one or more devices. Input/output unit 406 includes an input/output set of signal lines that couple the wireless interface device 400 to at least one user input device, e.g., keyboard and/or mouse.

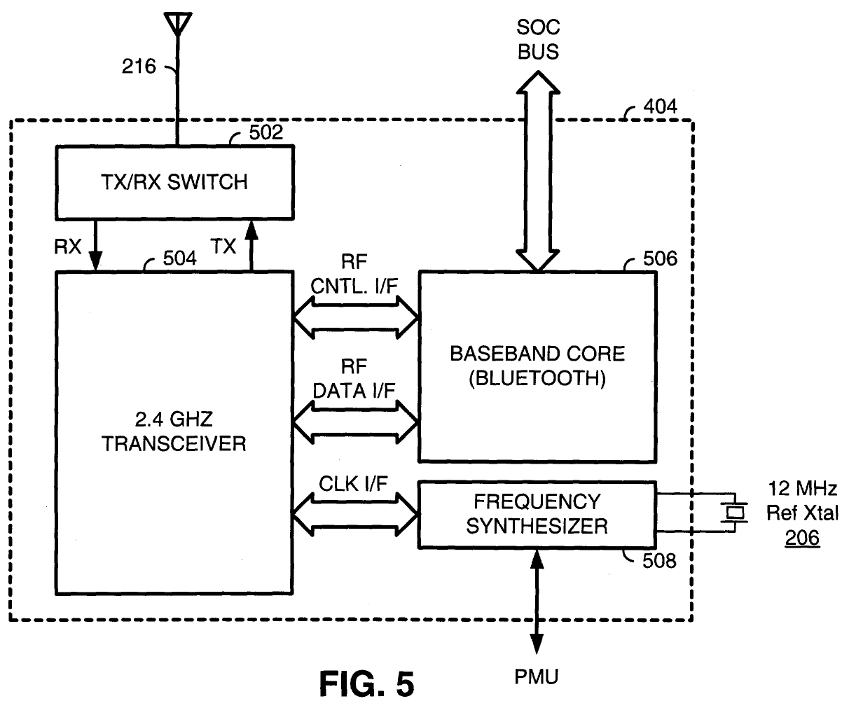

FIG. 5 is a block diagram illustrating a wireless interface unit of the wireless interface device of FIG. 4. The wireless interface unit 404 includes a transmit/receive switch 502, a 2.4 GHz transceiver 504, a Bluetooth core 506, and a frequency synthesizer 508. Each of these components is generally known in the field and will be described in minimal detail herein.

The transmit/receive switch 502 couples to antenna 216 and switches between transmit and receive operations. The 2.4 GHz transceiver 504 performs all RF front-end operations and operates within a frequency band and on particular channels as are specified by the Bluetooth operating standard. The 2.4 GHz transceiver 504 couples to baseband core 506, which in the present invention is a Bluetooth baseband core. Such coupling is performed via an RF control interface and an RF data interface. The RF control interface performs the necessary control operations to guarantee that the 2.4 GHz transceiver 504 and the baseband core 506 will operate consistently with desired operating specifications. The RF data interface transfers both Rx and TX data between the 2.4 GHz transceiver 504 and the baseband core 506. Frequency synthesizer 508 couples to the power management unit 408, to the external crystal 206 operating at 12 MHz, and to the 2.4 GHz transceiver 504. The frequency synthesizer 508 is controlled to provide an RF frequency for the 2.4 GHz transceiver 504 which is used to mix with the baseband signal received from the baseband core during a transmit operation and to mix with the received RF signal during a receive operation. The baseband core 506 couples to other wireless interface devices via the SOC bus 410.

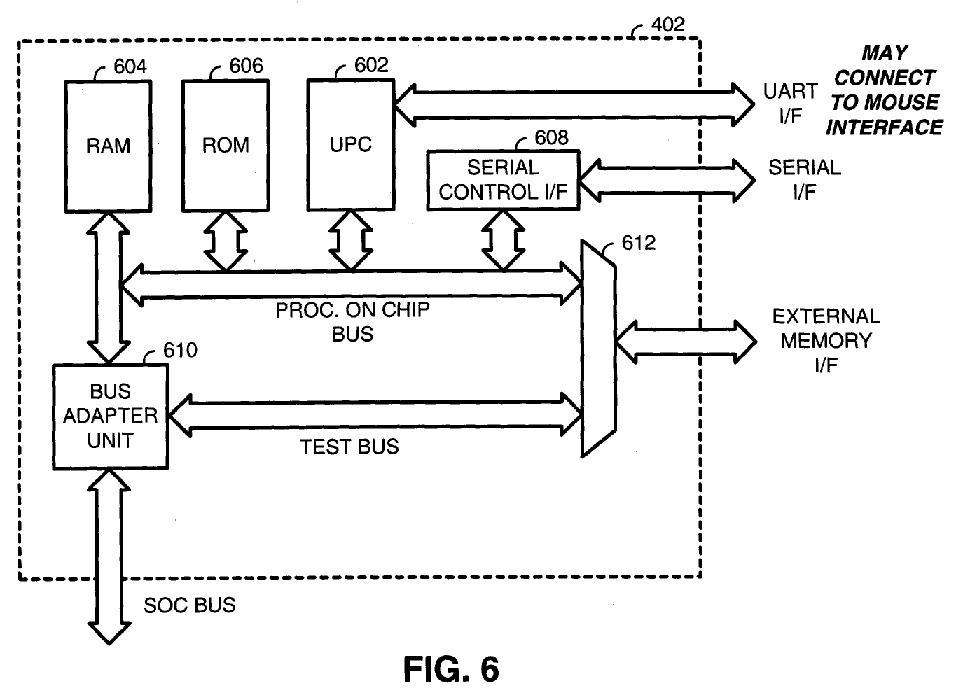

FIG. 6 is a block diagram illustrating a processing unit 402 of the wireless interface device of FIG. 4. The processing unit 402 includes a microprocessor core 602, read only memory 606, random access memory 604, serial control interface 608, bus adapter unit 610, and multiplexer 612. The microprocessor core 602, ROM 606, RAM 604, serial control interface 608, bus adapter unit 610, and multiplexer 612 couple via a processor on a chip bus. Multiplexer 612 multiplexes an external memory interface between the processor on a chip bus and a test bus. The bus adapter unit 610 interfaces the processor on a chip bus with the SOC. The microprocessor core 602 includes a Universal Asynchronous Receiver Transmitter (UART) interface that allows direct access to the microprocessor core 602. Further, the serial control interface 608 supports a serial interface that provides a serial interface path to the processor on a chip bus.

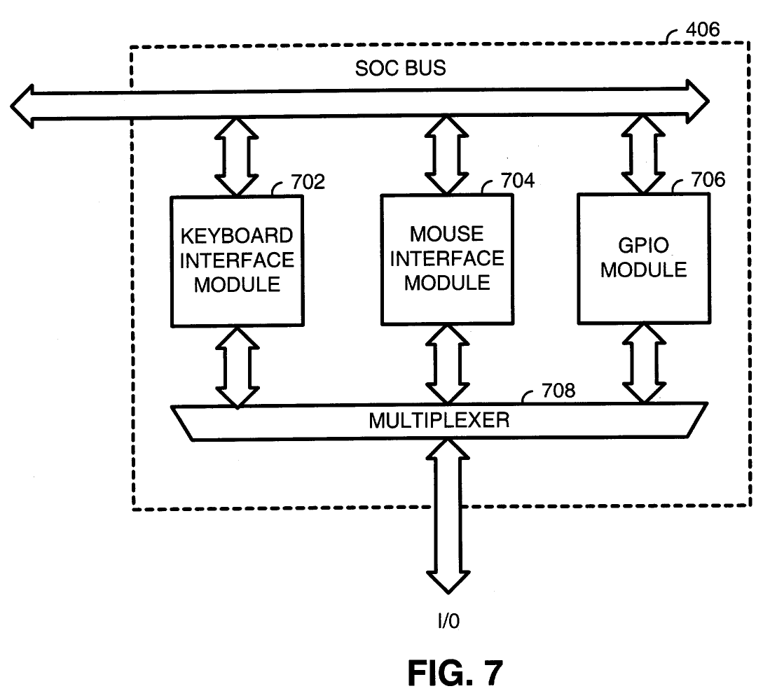

With the processing unit 402 of FIG. 6, the processing unit 402 may service a user input device via the UART interface and/or the serial interface. For example, in one contemplated application, an optical mouse IC will coupled to the processing unit 402 via the UART interface (or the serial interface). In such case, the mouse could be serviced via this interface path instead of via the input/output unit 406 as will be further described with reference to FIGS. 7, 11, and 13.

With the processing unit 402 of FIG. 6, the processing unit 402 may also service a user input device via the external memory interface. For example, in one contemplated application, a keyboard IC will coupled to the processing unit 402 via the external memory interface. In such case, the mouse could be serviced via this interface path instead of via the input/output unit 406 as will be further described with reference to FIGS. 7, 11, and 13. FIG. 7 is a block diagram illustrating an input/output unit 406 of the wireless interface device of FIG. 4. The input/output unit 406 includes a keyboard interface module 702, a mouse interface module 704, and a General Purpose Input/Output (GPIO) module 706. Each of the keyboard interface module 702, the mouse interface module 704, and the GPIO module 706 couple to the SOC bus. Further, each of the keyboard interface module 702, the mouse interface module 704, and the GPIO module 706 couple to I/O via multiplexer 708. This I/O couples to the at least one user input device.

In another embodiment of the input/output unit 406, each of the keyboard interface module 702, the mouse interface module 704, and the GPIO module 706 couples directly to external pins that couple to the at least one user input device.

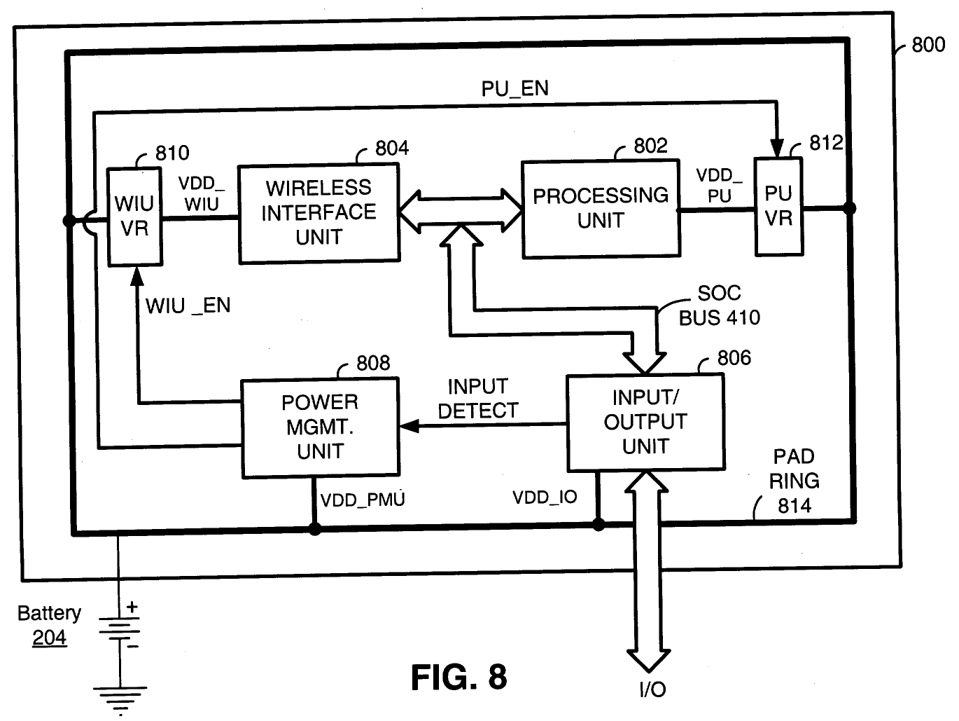

FIG. 8 is a block diagram generally showing the structure of an integrated circuit constructed according to the present invention with particular detail in the coupling of battery power to the units of the device. Integrated circuit 800 of FIG. 8 includes a wireless interface unit 804, processing unit 802, input/output unit 806, and power management unit 808. The processing unit 802, the wireless interface unit 804, and the input/output unit 806 intercouple via a SOC bus 410. Further, as was previously described, input/output unit 806 couples to at least one user input device via I/O connection.

With the integrated circuit 800 of FIG. 8, a pad ring 814 surrounds a substantial portion of the components of the integrated circuit. The pad ring 814 couples directly to battery 204, which powers the pad ring. Further, input/output unit 806 and power management unit 808 couple directly to pad ring 814 to receive their power and voltage. However, processing unit 802 couples to pad ring 814 via processing unit voltage regulation circuitry 812. Further, the wireless interface unit 804 couples to pad ring 814 via wireless interface unit voltage regulation circuitry 810. The processing unit voltage regulation circuitry 812 is controlled by the power management unit 808 via control signal PU_EN. Further, the wireless interface unit voltage regulation circuitry 810 is controlled by the power management unit 808 using control signal WIU_EN.

In another embodiment, the input/output unit 806 receives power separate from the power for the processing unit 802 and wireless interface unit 804. Furthermore, the output from the processing unit voltage regulation unit 812 goes off chip 800, where it is then fed back on chip 800 via a separate pin to feed the wireless interface unit 804. The wireless interface unit contains one or more switches to switch power on and off to its own sub-circuits under control of the power management unit 808. In this embodiment, the need for wireless interface unit voltage regulation means 810 is eliminated.

In still another embodiment, an additional power source is supplied to the chip 800, which feeds the input/output buffers for the external memory interface (shown in FIG. 6). This allows the IC to interface with external devices, which may utilize different I/O voltage levels than the I/O from the input/output unit 806.

The integrated circuit operates in four different power-conserving modes: (1) busy mode; (2) idle mode; (3) suspend mode; and (4) power down mode. Busy mode, idle mode, and suspend mode are described in the HID Profile specification which is a component of the Bluetooth specification. However, power down mode is unique to the present invention.

In busy mode, the master (host computer) is actively polling the slave (HID, e.g., wireless mouse, wireless keyboard, etc.) for data at a polling rate near 100 polls/second, or about once every 16 slot times. This mode is generally implemented using the Bluetooth low-power mode known as SNIFF mode. In SNIFF mode, the master polls the slave only at given intervals specified as some even number of Bluetooth slots. This is in contrast to ACTIVE mode in which the master may poll the slave at any slot. Continued user activity (keypad strokes, mouse motion, button presses, etc.) keeps the slave in busy mode. If there has been no activity for a certain time (pre-determined by custom settings), operation transitions to idle mode.

In idle mode, the slave requests that the master (serviced host) allow it to enter SNIFF mode with a SNIFF interval that is chosen based on desired latency and average power consumption. In one operation, the SNIFF interval is 50 milliseconds (ms), or about once every 80 slot times. While in idle mode, the slave needs only to listen for polls from the master at the SNIFF intervals to maintain synchronization, and to transmit a packet periodically to the master to keep the master from timing out the slave's connection. Since the slave transmits much less often in idle mode than in busy mode, its power consumption is greatly reduced. Although the slave can wake up immediately after an event, it may have to wait up to 100 ms to transmit its data to the host, and therefore must have enough buffer space to store 100 ms of events. If an event occurs, the slave requests the master to leave SNIFF mode. If there is no further activity for a longer period, the slave transitions from idle mode to suspend mode.

When entering suspend mode, there is a brief return on the connection state to ACTIVE mode to renegotiate the SNIFF interval to the suspend interval time. In suspend mode, a SNIFF interval that is longer than the SNIFF interval used for idle mode can be used for an even lower power state. As in idle mode, any user input detected while in suspend mode will result in the slave requesting that the master allow it to be transitioned back to the busy mode. As long as the master continues transmitting (meaning the host is not turned off) the slave will remain in suspend mode. If link loss occurs due to the host being turned off without warning, or the host moving out of range, the Lost Link state will be entered.

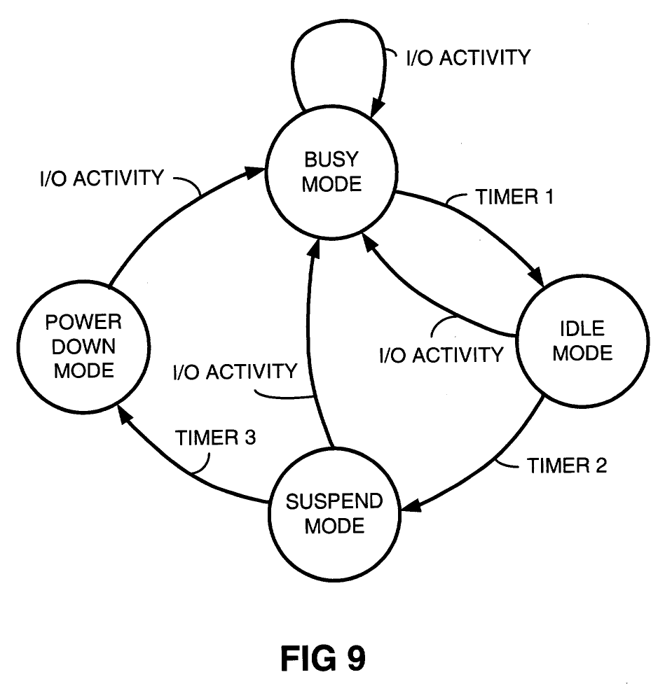

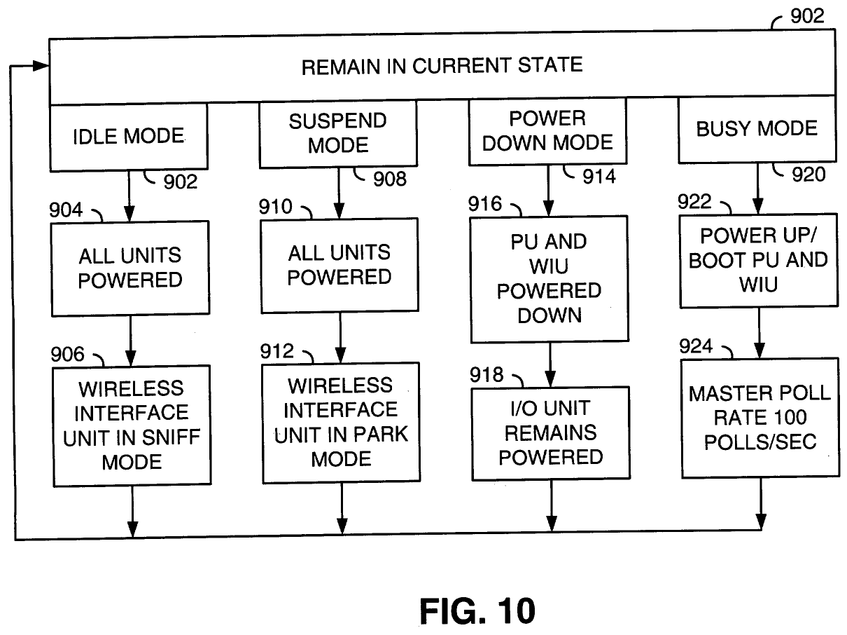

According to the present invention, the power down mode is also supported. In the power down mode, the power management unit 808 operates the processing unit voltage regulation circuitry 812 and the wireless interface unit voltage regulation circuitry 810 to power down the processing unit 802 and wireless interface unit 804, respectively. These states of operation will be described further with reference to FIGS. 9 and 10. In the power down mode link with the host is lost.

FIG. 9 is a state flow diagram illustrating operation according to the present invention. As illustrated in FIG. 9, a wireless interface device operating according to the present invention operates in four separate power conservation modes. These power conservation modes include the busy mode, the idle mode, the suspend mode and, the power down mode. The state diagram of FIG. 9 shows how each of these modes is reached during normal operation.

When the wireless interface device is initially powered up, it enters the busy mode of operation. In the busy mode of operation, all features and wireless operations of the wireless interface device are enabled. As long as I/O activity continues, the wireless interface device remains in the busy mode. However, after expiration of a first timer with no I/O activity, the operation moves from the busy mode to the idle mode. Operation will remain in idle mode until the expiration of a second timer or until I/O activity occurs.

If while in the idle mode I/O activity occurs, operation returns to the busy mode. If in the idle mode, if timer 2 expires with no additional I/O activity, suspend mode is entered. While in suspend mode, if I/O activity occurs, operation returns to busy mode. However, if in suspend mode, no additional I/O activity occurs until the expiration of a third timer, power down mode is entered. While in the power down mode, operation will remain in the power down mode until I/O activity occurs. When I/O activity occurs, operation of the wireless interface device will move from the power down mode to the busy mode.

One skilled in the art will immediately recognize that other embodiments can be realized which include fewer or more modes than those so far described. For example, in one potential embodiment, the suspend mode would not be used, and only the busy, idle, and power down modes would be implemented. In another embodiment, additional and even lower power modes than the suspend mode may be implemented which will be entered in sequence upon increasingly longer periods of input inactivity by the user following the suspend mode, and prior to entering the power down mode. In still another embodiment, the power down mode may not be implemented, and the HID device will remain connected regardless of the duration of time during which there is no user input activity.

FIG. 10 is a state flow diagram illustrating operation according to the present invention in controlling the power consumption of a serviced device. As shown in FIG. 10, once operation in a particular power conservation state, e.g., busy mode, idle mode, suspend mode, and power down mode has commenced, operation will remain in that state until expiration of respective timer or I/O activity occurs (step 902).

When power conservation operation occurs to move from the busy mode to the idle mode (step 902), all portions of the wireless interface device remain powered (step 904). However, in the idle mode, the wireless interface unit enters a sniff mode in which some of its operations are reduced. Such operations were previously described with reference to FIG. 9. Further, additional information regarding this mode is available in the Bluetooth HID standard.

When the operation of the wireless interface device transitions from the idle mode to the suspend mode (step 908) all portions of the wireless interface device remain powered (step 910).

When in the suspend mode if an additional timer or inactivity period expires, the wireless interface device will transition to the power down mode (step 914). In the power down mode, the processing unit and wireless interface unit will be powered down (step 916). This power down operation will be performed in one embodiment by simply disconnecting a voltage source from the processing unit in the wireless interface unit. One such technique for doing this is described with reference to FIG. 8. In the power down mode, the I/O unit will continue to be powered into sense the state of the user input device lines.

Finally, from any of the reduced power operating states, when I/O activity is sensed by the I/O block, the wireless input device will transition back to the busy mode (step 920). When such operation occurs, if the components have been powered down, they will be a powered up and will go through their boot operations (step 922). Then, in the busy mode, the wireless interface unit will operate in its normal state in which the master wireless device, i.e., wirelessly enabled host will poll the wireless interface device at 100 times per second. From each of steps 906, 912, 918, and 924, operation returns to step 902 wherein the current power conservation state will be kept until another event occurs.

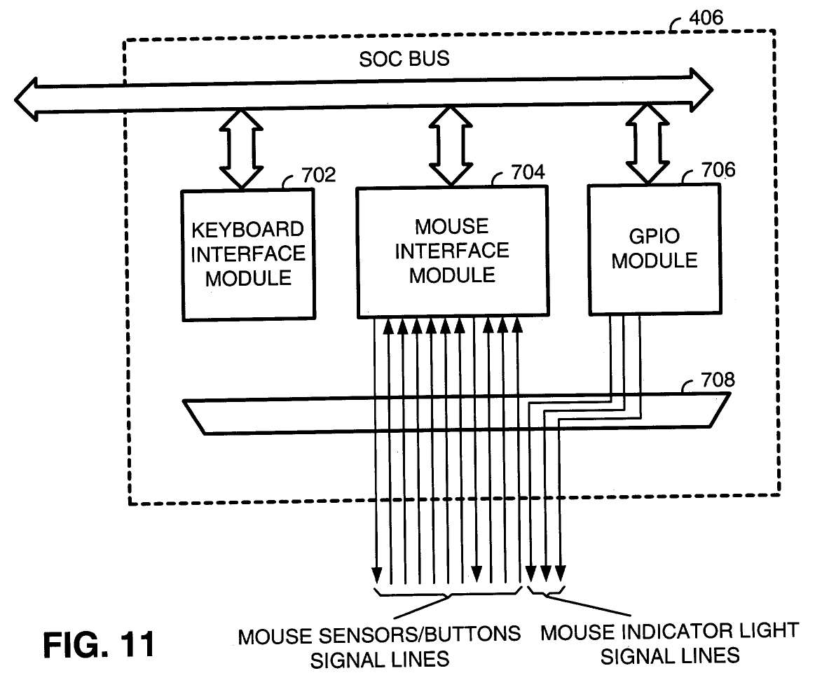

FIG. 11 is a block diagram illustrating the input/output unit of FIG. 7 configured in a first configuration in which a mouse is serviced. In the configuration of FIG. 11, a plurality of mouse sensors/buttons signal lines are coupled by the multiplexer 708 to the mouse interface module 704. These signal lines correspond generally to the signal lines illustrated in FIG. 2. Thus, the mouse sensors/buttons signal lines include both input and output signal lines. Further, in the configuration of FIG. 11, the multiplexer 708 also couples one or more output signal lines from the GPIO module 708 to the mouse. These output signal lines may be used to power the mouse, provide input to indicator lights of the mouse, or to provide other function(s). Further, in other embodiments, the multiplexer 708 may also couple one or more input signal lines from the mouse to the GPIO module 708.

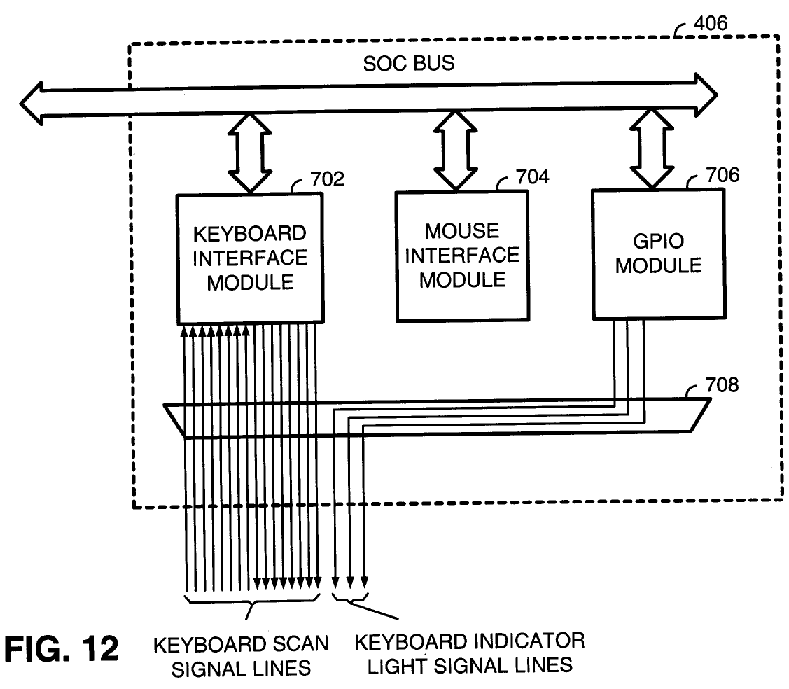

FIG. 12 is a block diagram illustrating the input/output unit of FIG. 7 configured in a second configuration in which a keyboard is serviced. In the configuration of FIG. 12, a plurality of keyboard scan input signal lines (inputs and outputs) are coupled by the multiplexer 708 between the keyboard (keyboard scan matrix) and the keyboard interface module 704. These keyboard scan signal lines correspond generally to the signal lines illustrated in FIG. 3. Further, in the configuration of FIG. 12, the multiplexer 708 also couples one or more output signal lines from the GPIO module 708 to the keyboard. These output signal lines may be used to power the keyboard, provide input to indicator lights of the keyboard, or to provide other function(s). Further, in other embodiments, the multiplexer 708 may also couple one or more input signal lines from the keyboard to the GPIO module 708. These additional input signal lines may support extended keyboard features such as one-button application launch, web browsing controls, etc.

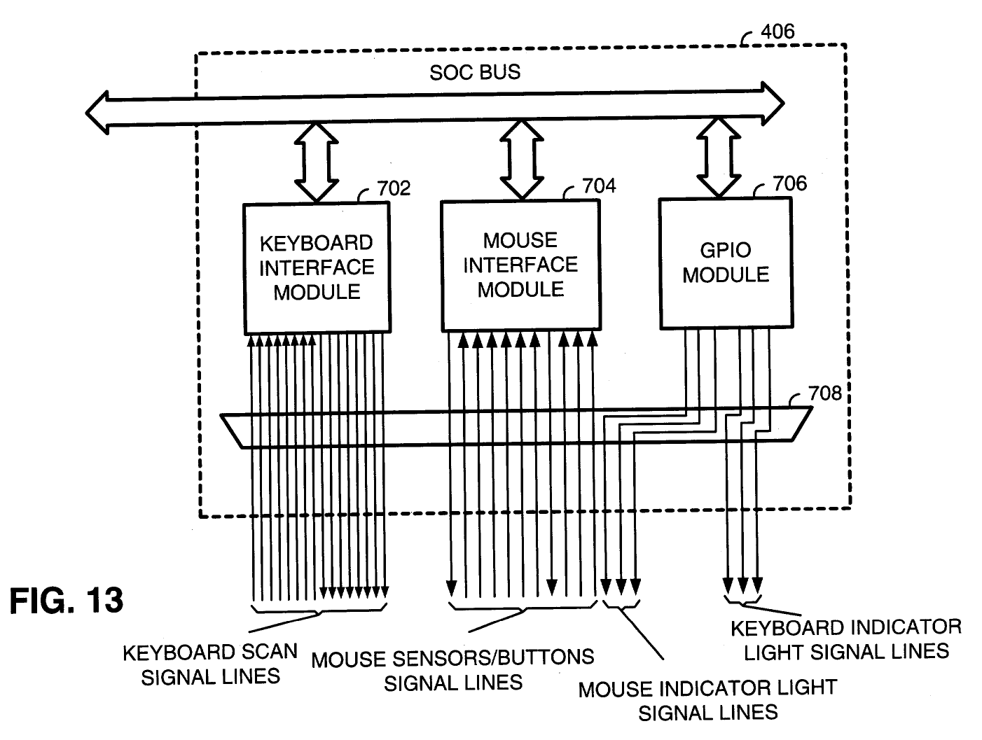

FIG. 13 is a block diagram illustrating the input/output unit of FIG. 7 configured in a third configuration in which both a mouse and a keyboard are serviced. In this third configuration, the multiplexer 708 supports some or all of the couplings that were described with reference to FIGS. 11 and 12. In particular, the multiplexer 708 couples signals between the keyboard interface module 702 and a serviced keyboard, couples signals between the mouse interface module 704 and a coupled mouse and couples signals between the GPIO module 706 and the mouse and/or keyboard. However, in the configuration of FIG. 13, not all of the signal couplings illustrated with reference to FIGS. 11 and 12 need be serviced.

With the configuration of FIG. 13, the wireless interface device, of course, services both a keyboard and a mouse. However, the wireless interface device includes wired connections to both the keyboard and the mouse. Thus, in the configuration of FIG. 13, the serviced mouse and the serviced keyboard must be formed in a single unit or must be tethered to one another to support this wired connection.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A wireless interface device that services communications between a wirelessly enabled host and a user input device, the wireless interface device comprising:
a system bus;
a wireless interface unit operably coupled to the system bus that wirelessly interfaces with the wirelessly enabled host;
a processing unit operably coupled to the system bus; and
an input/output unit including:
a keyboard interface module operably coupled to the system bus;
a pointing device interface module operably coupled to the system bus;
a General Purpose Input/Output (GPIO) module operably coupled to the system bus;
a multiplexer operably coupled to the keyboard interface module, to the pointing device interface module, and to the GPIO module, wherein the multiplexer is communicatively coupled to the user input device; and
wherein the multiplexer is configurable to couple signals between the user input device and at least one of the keyboard interface module, the pointing device interface module, and the GPIO module.

2. The wireless interface device of claim 1, wherein:
the user input device is a keyboard; and
the multiplexer is configurable to couple input signals from the keyboard to the keyboard interface module and to couple input/output signals to/from the GPIO module from/to the keyboard.

3. The wireless interface device of claim 1, wherein:
the user input device is a pointing device; and
the multiplexer is configurable to couple input signals from the pointing device to the pointing device interface module and to couple input/output signals to/from the GPIO module from/to the pointing device.

4. The wireless interface device of claim 1, wherein:
the multiplexer is configurable in a first configuration to couple input signals from the user input device to the keyboard interface module and to couple output signals from the GPIO module to the pointing device; and
the multiplexer is configurable in a second configuration to couple input signals from the user input device to the pointing device interface module and to couple output signals from the GPIO module to the pointing device.

5. The wireless interface device of claim 1, wherein the wireless interface unit supports the Bluetooth Specification.

6. The wireless interface device of claim 1, wherein:
the user input device includes both a keyboard and a pointing device; and
the multiplexer is configurable to:
couple input signals from the keyboard to the keyboard interface module and to couple output signals from the GPIO module to the keyboard; and
couple input signals from the pointing device to the pointing device interface module.

7. The wireless interface device of claim 6, wherein the pointing device and the keyboard are tethered to one another.

8. The wireless interface device of claim 1, wherein the processing unit further includes a pointing device interface.

9. The wireless interface device of claim 8, wherein:
in a first configuration the wireless interface device services a pointing device via the pointing device interface of the processing unit; and
in a second configuration the wireless interface device services a pointing device via the pointing device interface module of the input/output unit.

10. The wireless interface device of claim 1, wherein the wireless interface device enters one of a plurality of power consumption operating states comprising:
busy mode in which all components of the wireless interface device are powered and operational;
idle mode in which the wireless interface unit performs first power conserving operations;
suspend mode in which the wireless interface unit performs second power conserving operations; and
power down mode in which the wireless interface unit and the processing unit are powered down.

11. The wireless interface device of claim 10, wherein in the idle mode the wireless interface unit periodically communicates with the wirelessly enabled host

12. The wireless interface device of claim 10, wherein in the power down mode, communication with the wirelessly enabled host is disabled.

13. An integrated circuit that services communications between a wirelessly enabled host and a user input device, the wireless interface device comprising:
a system bus formed on the integrated circuit;
a wireless interface unit formed on the integrated circuit that operably couples to the system bus, that wirelessly interfaces with the wirelessly enabled host, and that includes a connection for coupling to an antenna;
a processing unit formed on the integrated circuit that operably couples to the system bus; and
an input/output unit formed on the integrated circuit includes:
a keyboard interface module operably coupled to the system bus;
a pointing device interface module operably coupled to the system bus;
a General Purpose Input/Output (GPIO) module operably coupled to the system bus;
a multiplexer operably coupled to the keyboard interface module, to the mouse interface module, and to the GPIO module, wherein the multiplexer is communicatively coupled to the user input device via a plurality of signal lines; and
wherein the multiplexer is configurable to couple the plurality of signal lines to at least two of the keyboard interface module, the pointing device interface module, and the GPIO module.

14. The integrated circuit of claim 13, wherein:
the user input device is a keyboard; and
the multiplexer is configurable to couple a plurality of the signal lines to the keyboard interface module and a plurality of the signal lines to the GPIO module.

15. The integrated circuit of claim 13, wherein:
the user input device is a pointing device; and
the multiplexer is configurable to couple a plurality of the signal lines to the pointing device interface module and to couple a plurality of the signal lines to the GPIO module.

16. The integrated circuit of claim 13, wherein:
the multiplexer is configurable in a first configuration to couple a plurality of the signal lines to the keyboard interface module and to couple a plurality of the signal lines to the GPIO; and
the multiplexer is configurable in a second configuration to couple a plurality of the signal lines to the pointing device interface module and to couple a plurality of the signal lines to the GPIO module.

17. The integrated circuit of claim 13, wherein the wireless interface unit supports the Bluetooth Specification.

18. The integrated circuit of claim 13, wherein:
the user input device includes both a keyboard and a pointing device; and
the multiplexer is configurable to:
couple a first plurality of the signal lines servicing the keyboard to the keyboard interface module:
couple a second plurality of signal lines servicing the keyboard to the GPIO module;
couple a third plurality of the signal lines servicing the pointing device to the pointing device interface module; and
couple a fourth plurality of the signal lines servicing the pointing device to the GPIO module.

19. The integrated circuit of claim 18, wherein the pointing device and the keyboard are tethered to one another.

20. The integrated circuit of claim 13, wherein the processing unit further includes a pointing device interface.

21. The integrated circuit of claim 20, wherein:
in a first configuration the integrated circuit services a pointing device via the pointing device interface of the processing unit; and
in a second configuration, the integrated circuit services a pointing device via the pointing device interface module of the input/output unit.

22. The integrated circuit of claim 13, wherein the integrated circuit enters one of a plurality of power consumption operating states comprising:
busy mode in which all components of the integrated circuit are powered and operational;
idle mode in which the wireless interface unit performs first power conserving operations;
suspend mode in which the wireless interface unit performs second power conserving operations; and
power down mode in which the wireless interface unit and the processing unit are powered down.

23. The integrated circuit of claim 22, wherein in the idle mode the wireless interface unit periodically communicates with the wirelessly enabled host.

24. The integrated circuit of claim 22, wherein in the power down mode, communication with the wirelessly enabled host is disabled.
